(19) United States
(12) Patent Application Publication
(10) Pub. No.: US 2012/0062751 A1
(43) Pub. Date: Mar. 15, 2012

(54) CAPTURE OF THERMAL IMAGES OF AN OBJECT

(76) Inventors: Christian Homma, Vaterstetten (DE); Max Rothenfusser, Munchen (DE)

(21) Appl. No.: 13/320,506

(22) PCT Filed: Apr. 26, 2010
(86) PCT No.: PCT/EP2010/055529

§ 371 Date: Nov. 14, 2011

(30) Foreign Application Priority Data
May 14, 2009 (DE) 10 2009 021 233.7

(51) Int. Cl. H04N 5/33; G01S 15/89

(52) U.S. Cl. 348/163; 348/164; 348/E05.09; 348/E07.085

(57) ABSTRACT

An apparatus with an excitation unit for mechanically exciting an object with a periodic excitation signal and a camera for capturing the thermal images of the object are used to capture thermal images of the object. The thermal image has a plurality of pixels, where a pixel is respectively intended to represent a heat signal acquired from the object. The apparatus matches a capture of the thermal images of the object and the periodic excitation signal in such a manner that thermal images captured in a plurality of periods of the periodic excitation signal can be used to determine information relating to the heat signals respectively represented by the pixels during a period.

### CROSS REFERENCE TO RELATED APPLICATIONS

This application is the U.S. national stage of International Application No. PCT/EP2010/055529, filed Apr. 26, 2010 and claims the benefit thereof. The International Application claims the benefits of German Application No. 102009021233.7 filed on May 14, 2009, both applications are incorporated by reference herein in their entirety.

### BACKGROUND

Described below are an apparatus and a method for capturing thermal images of an object. Such an apparatus has an excitation unit for mechanical excitation of the object using a periodic excitation signal. Moreover, the apparatus has a camera for capturing the thermal images of the object.

Capturing thermal images is also referred to as thermography. Thermography is an imaging method that makes infrared radiation visible. The infrared radiation emitted by an object can be interpreted as a temperature distribution. To this end, a thermographic camera uses special sensors to convert the thermal radiation (infrared light), which is invisible to the human eye, from the object into electric signals, which can easily be processed. The term thermography is usually used as a synonym for the phrase infrared thermography. A problem in capturing thermal images from an object excited by a periodic excitation signal lies in the fact that currently available thermographic cameras only have a limited frame rate, typically in the range between 50 Hz and 1000 Hz. This limits the applicability of this technique.

EP 1 582 867 A2 discloses a fault detection system that evaluates thermal images of a structure excited by sonic or ultrasonic energy. The system contains a transducer for coupling a sound signal into the structure. The sound signal heats faults in the structure. A thermographic camera captures an image of the structure heated by the sound signal.

### SUMMARY

An aspect is improving the capture of thermal images of an object.

This aspect is achieved by an apparatus for capturing thermal images of an object, with an excitation unit for mechanical excitation of the object using a periodic excitation signal, with a camera for capturing the thermal images of the object, wherein a thermal image has a multiplicity of pixels, and with a pixel respectively being provided for representing a heat signal captured from the object, and with the capability of matching the process of capturing the thermal images of the object to the periodic excitation signal such that thermal images captured in a multiplicity of periods of the periodic excitation signal can be used to establish information in respect of the heat signals, respectively represented by the pixels, over a period.

This object is achieved by a method for capturing thermal images of an object, with the following operations:
mechanical excitation of the object using a periodic excitation signal,
capturing the thermal images of the object, wherein a thermal image has a multiplicity of pixels, a pixel respectively representing a heat signal captured from the object,
   wherein the process of capturing the thermal images of the object is matched to the mechanical excitation using the periodic excitation signals such that thermal images captured in a multiplicity of periods of the periodic excitation signal can be used to establish information in respect of the heat signals, respectively represented by the pixels, over a period.

The apparatus is based on the idea of using the periodicity of the mechanical excitation of an object in a novel fashion in order to compensate for the limited frame rate of a camera for capturing thermal images. The advantage of the mechanical excitation with a periodic excitation signal lies in the fact that the thermal replies of the object excited by the mechanical excitation substantially repeat during each period of the periodic excitation signal. Hence, in order to establish information in respect of the heat signals over a period, which heat signals are respectively represented by the pixels in a thermal image and emitted by the object, it is sufficient to detect and evaluate the appropriate heat signal during a plurality of periods of the periodic excitation signal at respectively appropriately selected times. In order to make this possible, the process of capturing the thermal images of the object is matched to the periodic excitation signal. This allows significantly higher frequencies of the periodic excitation signal and thereby opens up entirely new fields of application for such a method.

As per one advantageous embodiment, the information contains a profile of the heat signal over a period of the periodic excitation signal. This offers the advantage of being able to determine a profile of the heat signals despite the frame rate of the camera being low compared to the frequency of the periodic excitation signal.

As per a further advantageous embodiment, the information contains an amplitude and a phase of the heat signals. This offers advantages particularly in applications in which the precise profile of a heat signal is unimportant but in which information in respect of the amplitude or the phase of the heat signal is sufficient.

Advantageously, the camera is provided for capturing a sequence of the thermal images of the object. Such a sequence more particularly includes a sufficient number of thermal images in order to be able to establish the information in respect of the heat signals, respectively represented by the pixels, over a period of the periodic excitation signal.

As per a further advantageous embodiment, evaluation is provided for establishing the information in respect of the heat signals, respectively represented by the pixels, over a period. By way of example, evaluation means may be embodied by one or more computers.

The matching of the process of capturing the thermal images of the object to the periodic excitation signal is advantageously embodied by including a pulse transmitter unit for generating sampling pulses, wherein the camera and the pulse transmitter unit are coupled to one another such that capturing one of the thermal images can be triggered by one of the sampling pulses. This affords temporally precise triggering of the camera for capturing the thermal images.

As per a further advantageous embodiment, this is more particularly used so that, for a respectively later period of the excitation signal, it is possible to generate a sampling pulse with a continuously increasing delay compared to a sampling pulse generated for a respectively earlier period of the excitation signal. The effect of this delayed sampling is that this allows capture and evaluation of different sections of the respective heat signal over the period of time of a plurality of periods of the excitation signal. Here, this sampling pulse can be generated after respectively one period or after respectively a multiple of periods of the excitation signal, depending on the embodiment.

In a further advantageous embodiment, evaluation is provided for determining frequency components of the heat signals. In particular, this makes it possible to determine fundamental frequency components and components of higher harmonics.

As per a further advantageous embodiment, the advantages thereof are particularly pronounced if the periodic excitation signal has a frequency of between 2 kHz and 200 kHz, more particularly a frequency in the ultrasonic range.

In particular, the method can be used for fault detection, for measuring mechanical stresses and/or for fatigue analysis of an object.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic block diagram of an apparatus for capturing thermal images of an object,

FIG. 2 is a graph of a periodic excitation signal and heat signals caused thereby,

FIG. 3 is a stress-strain diagram,

FIG. 4 is a graph illustrating a thermal signal capture over a plurality of periods,

FIG. 5 is a graph illustrating a parameter determination by a lock-in technique,

FIG. 6 is a graph illustrating the capture of a heat signal, and

FIG. 7 is a graph of a resulting signal if the lock-in technique is applied.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The thermographic examination of a periodically excited object provides many different items of information relating to the respective object. The development of the technique mainly depends on the availability of fast and sensitive thermographic cameras, more particularly infrared cameras. Typical applications are fault detection using acoustic thermography, measuring stress distributions and also fatigue analysis of an object. According to the related art, different measurement systems are required for each of these applications. The frame rate of commercially available cameras typically lies in the range between 50 Hz and 1000 Hz (complete individual image). This limits the applicability of the technique. Until now there have not been satisfactory solutions for the examination methods described in the following text.

For nondestructive testing by acoustic thermography, it is necessary to ensure that the maximum mechanical stress on an object is not exceeded anywhere on the object. However, until now it has not been possible to use infrared cameras to measure and display the stress distribution for excitations in the upper audible range (a few kHz) and into the ultrasonic range.

The ability to find cracks is determined by both the size and morphology thereof. In the case of closed cracks in particular, the signal-to-noise ratio is often too low in acoustic thermography, and so it is very likely that these faults are not found during an examination. A lock-in technique, based on the excitation frequency (e.g. 20 kHz), would significantly increase the detectability. However, the available frame rates of commercially available infrared cameras are not suitable for resolving the heat signal in the ultrasonic range.

The thermographic life-time prediction based on a periodic load is likewise limited by the available frame rate of the infrared camera. A maximum excitation frequency of approximately 30 Hz has previously been disclosed. Moreover, this technique cannot simply be applied to all test objects; rather, it is only available for appropriately designed test objects.

Hence, the limited frame rate of infrared cameras is the crucial issue in this case. The currently achievable maximum frequency for high-speed cameras in the full-screen mode is approximately 1000 Hz. If, for example, each period of the heat signal should be resolved with N=10 samples per period, the maximum mechanical excitation frequency is 100 Hz.

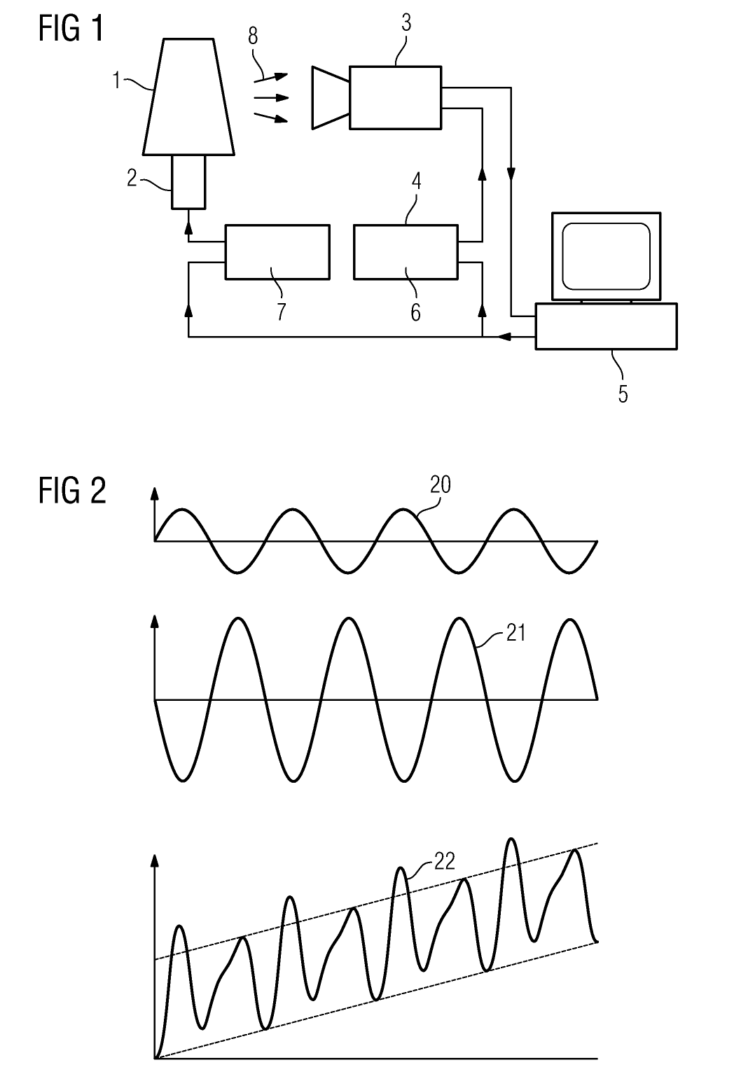

The following text describes the required components and techniques for a frequency-resolved acoustic thermography application. A schematic system design of an apparatus for capturing thermal images of an object 1 is shown in FIG. 1. The apparatus has an excitation unit 2 for mechanical excitation of the object 1 using a periodic excitation signal. A camera 3 serves for capturing the thermal images of the object 1. A thermal image has a multiplicity of pixels. A pixel respectively serves to represent a heat signal 8 captured from the object 1. The apparatus has means 4 for matching the process of capturing the thermal images of the object 1 to the periodic excitation signal. The means 4 have a pulse transmitter unit 6 for generating sampling pulses, also referred to as stroboscopic signals in the following text. There are different ways of generating the stroboscopic signal:
A microcontroller is programmed such that it provides sampling pulses with an increasing delay.
A specially developed electronic circuit with hardware components (counter, clock with delay function).
Commercially available plug-in circuits for computers, with counters, time function and delay function.

As per the exemplary embodiment shown in FIG. 1, the excitation signal emitted to the object 1 by the excitation unit 2 is generated in a generator 7. Use can be made of any known type of excitation in the acoustic or ultrasonic range (e.g. electromagnetic excitation, piezo-oscillator, ultrasonic cleaning baths, electromagnetic acoustic transducer (EMAT), etc.).

The process of capturing thermal images of the object 1 is matched to the mechanical excitation using the periodic excitation signal such that thermal images captured in a multiplicity of periods of the periodic excitation signal can be used to establish information in respect of the heat signals 8, respectively represented by the pixels, over a period. Evaluation means 5 are used to establish the information in respect of the heat signals 8, respectively represented by the pixels, over a period.

The recorded heat signals 8 are subjected to post-processing for each individual camera pixel. Both Fourier analysis and also the lock-in technique are methods for determining the magnitude (amplitude and phase) of the fundamental frequency, the higher harmonics and every additional relevant frequency component. The required post-processing depends on the respective application.

FIG. 2 shows the time profile of a periodic excitation signal 20. Moreover, the thermoelastic component 21 of a heat signal, emitted by an object excited by the excitation signal 20, and the thermoplastic component 22 of the heat signal are illustrated schematically. The heat signals emitted by the object represent the thermal replies to the periodic excitation. The scaling of the horizontal time axes is the same in each case in order to simplify a comparison of the illustrated signals at particular times.

The frequency component with the frequency fₛ is based on the so-called thermoelastic effect and can be applied for evaluating the local stress. The thermoelastic effect is a reversal of the known thermal expansion and causes the periodic heating and cooling of the object.

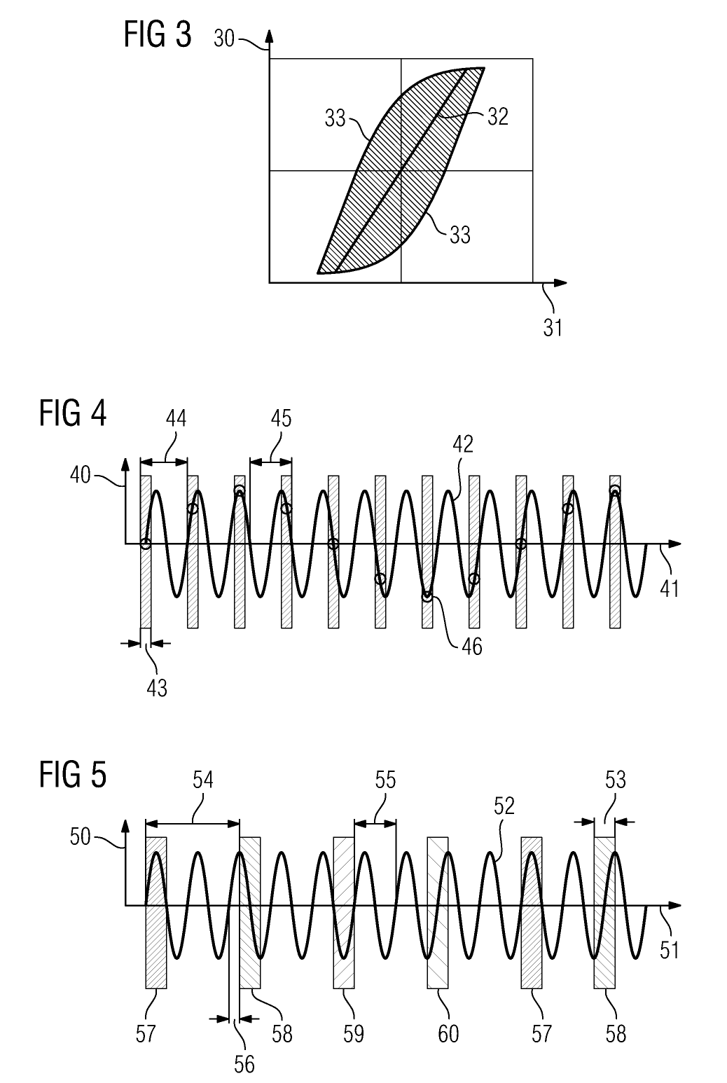

FIG. 3 shows a typical stress-strain diagram for a cyclically excited object. Here, the mechanical stress a (ordinate 30) is plotted against the strain E (abscissa 31). Reference sign 32 denotes a linear elastic stress-strain curve, reference sign 33 denotes a schematic elastic-plastic stress-strain curve. There is a hysteresis in the elastic-plastic stress-strain curve 33.

All higher harmonics of the heat signal are based on the nonlinear mechanical behavior of the test object, which becomes noticeable as a hysteresis in the stress-strain relation. This thermoplastic effect is nonreversible and causes an increase in temperature in both the compression and stress phase of the excitation. Therefore the heat signal has a frequency component with a double basic frequency fₛ, additional higher harmonics and a temperature that increases over time.

In contrast to plastics, this effect is typically very small for metallic objects but can nevertheless be determined in certain materials, e.g. steel. Moreover, it offers a quantitative measure for the fatigue state of certain materials.

In the case of a crack, both the higher harmonics and the increasing temperature are a local phenomenon, which is caused by heat-radiating effects at the front of the crack or the tip of the crack (friction, damping, plastic deformation).

FIG. 4 shows a periodic heat signal 42 to be captured, the magnitude (ordinate 40) of which is plotted over time (abscissa 41). A period of the heat signal 42 is denoted by reference sign 45. The heat signal 42 is captured cyclically over a period with a duration of 44. Reference sign 43 denotes the integration time tᵢ of the camera capture (also referred to below as image recording time tᵢ). The region of the heat signal 42 respectively captured by the camera is marked by circles 46.

A trigger pulse for the camera with a continuously increasing delay Δt is generated for each successive period of the excitation signal with a frequency fₛ. If the maximum frame rate of the camera is not sufficiently high, this trigger pulse can also be generated in each case for a multiple of periods of the excitation signal. Thus, for example, in the case of an ultrasound frequency of 20 kHz and a frame rate of the camera of 1 kHz, a trigger for the camera is only triggered for every twentieth ultrasound period. Depending on the required time resolution, a number N of these sampling pulses is required for sampling and reconstructing a complete period of the infrared signal. Here, the stroboscopic sampling pulses are synchronized with the excitation signal. The parameters describing the stroboscopic signal are the excitation frequency fₛ and the number N of sampling intervals for a period and the corresponding resulting increasing time delay Δt. The image recoding time tᵢ must be adapted accordingly.

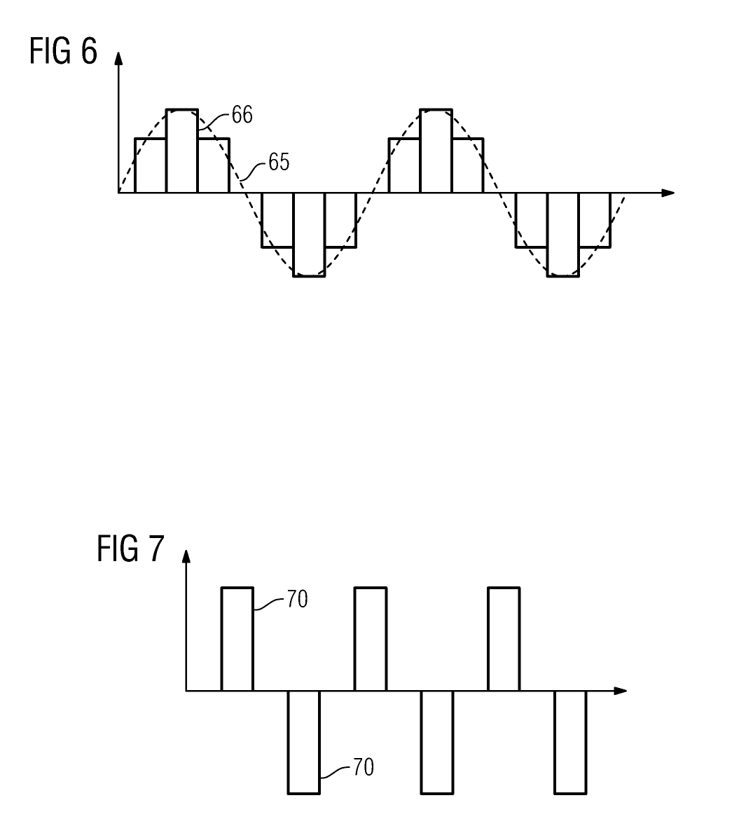

FIG. 5 shows how amplitude and phase of a heat signal are measured by the so-called stroboscopic lock-in technique. The signal strength (ordinate 50) of a heat signal 52 is plotted over time (abscissa 51). Reference sign 53 denotes the integration time tᵢ of the camera. The period duration tₐ of the capture is denoted by reference sign 54, the period duration tₛ of the signal is denoted by reference sign 55. As per the exemplary embodiment shown in FIG. 5, the heat signal 52 is captured during the time intervals 57, 58, 59 and 60. Let A be the captured value of the heat signal 52, integrated over the integration time 53, in the time interval 57. Accordingly, let B denote the value integrated in the time interval 58, let C denote the value from the time interval 59 and let D denote the value from the time interval 60. The delay of the capture in respect of the heat signal is denoted by reference sign 56 and has the value Δt. The following holds true for Δt=tₛ/4:

Amplitude=(¼)*(A−C)

Phase=0

The following relations emerge for an arbitrary value Δt:

Amplitude=(¼)*SQRT((A−C)2+(B−D)2)

Phase=arctan((B−D)/(A−C))

FIG. 6 shows the resulting signal 66 that approximates the profile of the heat signal 65 over a period of the periodic excitation signal.

FIG. 7 shows the resulting signal 70 that occurs during the capture of a heat signal by the lock-in technique described in conjunction with FIG. 5.

The described exemplary embodiments provide novel options for acoustic thermography, in which the frequency component of the heat signal is captured and processed for frequencies up into the ultrasonic range. A stroboscopic technique is proposed for resolving such a signal. A subsequent analysis provides the frequency components of the signal for each individual pixel in the image sequence.

Here, the fundamental frequency and the higher harmonics are used for different applications:

### 1. Determining Local Stresses in the Case of Periodic Excitation.

It is possible to visualize and quantitatively determine the stress distribution on a cyclically stressed test object for frequencies up into the ultrasonic range. The frequency component used for this is the fundamental frequency fₛ.

### 2. Fault Detection

This application is based on the higher harmonics (2fₛ, 3fₛ, etc.). Depending on the set parameters, there is an improvement in the signal-to-noise ratio and hence also in the probability of detecting faults compared to known techniques. As the utilized frequencies increase, there is a decrease in the blurring in the fault detection as a result of thermal diffusion. This allows more precise localization and magnitude determination of defects.

### 3. Thermographic Life-Time Predictions

This also utilizes the higher harmonics (2fₛ, 3fₛ, etc.). The proposed method avoids expensive immobile examination structures and the requirement for specially shaped test objects. Hence real test objects can be examined by being coupled to an excitation signal. Moreover, the examination time is significantly reduced because the utilized excitation frequency may be significantly higher.

The three described applications merely require a single experimental design (see FIG. 1). The proposed method provides a complete data record of the thermal response of a periodically stressed test object. Which application is selected is decided by merely the selection of the respective frequency component.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-13. (canceled)

14. An apparatus for capturing thermal images of an object, comprising:
an excitation unit producing mechanical excitation of the object using a periodic excitation signal;
a camera capturing the thermal images of the object with each thermal image having a plurality of pixels respectively representing heat signals captured from the object; and
means for matching the capturing of the thermal images of the object to the periodic excitation signal such that a set of the thermal images captured in multiple periods of the periodic excitation signal contain information regarding the heat signals, respectively represented by the pixels, over a period of time.

15. The apparatus as claimed in claim 14, wherein the information includes a profile of the heat signals over at least one period of the periodic excitation signal.

16. The apparatus as claimed in claim 15, wherein the information includes an amplitude and a phase of the heat signals.

17. The apparatus as claimed in claim 16, wherein said camera captures a sequence of the thermal images of the object.

18. The apparatus as claimed in claim 17, further comprising evaluation means for establishing the information regarding the heat signals, respectively represented by the pixels, over the period.

19. The apparatus as claimed in claim 18,
wherein said means for matching the capturing of the thermal images of the object to the periodic excitation signal includes a pulse transmitter unit generating sampling pulses, and
wherein said camera and the pulse transmitter unit are coupled together so that capturing one of the thermal images is triggered by one of the sampling pulses.

20. The apparatus as claimed in claim 19, wherein the pulse transmitter unit generates the sampling pulses with a continuously increasing delay relative to the excitation signal.

21. The apparatus as claimed in claim 20, wherein said evaluation means are provided for determining frequency components of the heat signals.

22. The apparatus as claimed in claim 21, wherein the periodic excitation signal has a frequency of between 2 kHz and 200 kHz, more particularly a frequency in the ultrasonic range.

23. The apparatus as claimed in claim 21, wherein the periodic excitation signal has an ultrasonic frequency.

24. The apparatus as claimed in claim 14,
wherein said means for matching the capturing of the thermal images of the object to the periodic excitation signal includes a pulse transmitter unit generating sampling pulses, and
wherein said camera and the pulse transmitter unit are coupled together so that capturing one of the thermal images is triggered by one of the sampling pulses.

25. The apparatus as claimed in claim 24, wherein the pulse transmitter unit generates the sampling pulses with a continuously increasing delay relative to the excitation signal.

26. The apparatus as claimed in claim 14, wherein said means for matching the capturing of the thermal images of the object to the periodic excitation signal includes a pulse transmitter unit generating sampling pulses with a continuously increasing delay relative to the excitation signal.

27. A method for capturing and evaluating thermal images of an object, comprising:
using a periodic excitation signal to produce mechanical excitation of the object; and
capturing the thermal images of the object with each thermal image having a plurality of pixels respectively representing heat signals captured from the object, said capturing of the thermal images of the object being matched to the mechanical excitation produced by the periodic excitation signal such that a set of the thermal images captured in multiple periods of the periodic excitation signal contain information regarding the heat signals, respectively represented by the pixels, over a period of time.

28. The method as claimed in claim 27, wherein the information contains a profile of the heat signals over at least one period of the periodic excitation signal and/or an amplitude and a phase of the heat signals.

29. The method as claimed in claim 28, wherein said capturing uses sampling pulses to trigger capture of the thermal images.

30. The method as claimed in claim 29, further comprising evaluating the information obtained from the thermal images to perform at least one of fault detection, measurement of mechanical stresses and fatigue analysis of the object.

31. The method as claimed in claim 28, further comprising evaluating the information obtained from the thermal images to perform at least one of fault detection, measurement of mechanical stresses and fatigue analysis of the object.

32. The method as claimed in claim 27, wherein said capturing uses sampling pulses to trigger capture of the thermal images.

33. The method as claimed in claim 27, further comprising evaluating the information obtained from the thermal images to perform at least one of fault detection, measurement of mechanical stresses and fatigue analysis of the object.
